(19) United States
(12) Patent Application Publication
(10) Pub. No.: US 2011/0063368 A1
(43) Pub. Date: Mar. 17, 2011

(54) Multi inkjet head package, inkjet recording apparatus using the same, and method of aligning the same in inkjet recording apparatus

(75) Inventors: Yong Sik Kim, Suwon (KR); Jae Woo Joung, Suwon (KR); Kwan Soo Yun, Suwon (KR); Won Chul Sim, Seongnam (KR); Pil Joong Kang, Suwon (KR)

(73) Assignee: SAMSUNG ELECTRO-MECHANICS CO., LTD., Suwon (KR)

(21) Appl. No.: 12/654,973

(22) Filed: Jan. 11, 2010

(30) Foreign Application Priority Data
Sep. 17, 2009 (KR) 10-2009-0088201

(51) Int. Cl. B41J 2/145

(52) U.S. Cl. 347/40

(57) ABSTRACT

There is provided a multi inkjet head package. The multi inkjet head package may include: a plurality of inkjet head assemblies each having a head plate in which an inkjet head discharging ink is housed; a rack in which the head plate is housed so as to expose the inkjet head; and a preliminary fixation portion that is installed on the rack and allows the head plate to be preliminarily fixed to the rack.

### CROSS-REFERENCE TO RELATED APPLICATIONS

This application claims the priority of Korean Patent Application No. 10-2009-0088201 filed on Sep. 17, 2009, in the Korean Intellectual Property Office, the disclosure of which is incorporated herein by reference.

### BACKGROUND OF THE INVENTION

1. Field of the Invention

The present invention relates to a multi inkjet head package, an inkjet recording apparatus using the multi inkjet head package, and a method of aligning a multi inkjet head package in the inkjet recording apparatus.

2. Description of the Related Art

Generally, inkjet heads are structures that convert an electrical signal into physical force and allow ink to be discharged from a minute nozzle in a liquid droplet form.

Recently, inkjet printing technology has been applied to various industrial fields relating to electronic apparatuses, textures, and the like. Presently, in the process of manufacturing PCBs, LCDs, PDPs, and the like, inkjet printing technology is being applied as a method for overcoming limits in regard to precision and productivity.

Such an industrial inkjet recording apparatus uses a plurality of heads for improving productivity and has been developed into a multi-head printing system capable of implementing high levels of precision and high resolution.

The above-described multi-head printing systems can print a large area with high precision. However, since a plurality of inkjet head assemblies are individually installed and aligned in an inkjet recording apparatus, many problems occur.

In particular, in order to individually align a plurality of inkjet head assemblies in the inkjet recording apparatus within a range of error of several μm, each inkjet head assembly must be installed in an expensive alignment support stand that controls the inkjet head assembly in directions X, Y, Z and θ. Accordingly, there are problems in that the size and the complexity of the inkjet recording apparatus increase, and the manufacturing cost rides.

In addition, since a plurality of inkjet head assemblies are installed with high precision in the alignment support stands, a high level of caution needs to be paid to the attachment or detachment of the inkjet head assemblies, the supply of ink, and the like.

### SUMMARY OF THE INVENTION

An aspect of the present invention provides a multi inkjet head package having high precision by preliminarily fixing inkjet head assemblies to a rack and aligning the inkjet head assemblies.

An aspect of the present invention also provides an inkjet recording apparatus which allows the multi inkjet head package to be aligned with high precision.

An aspect of the present invention also provides a method of aligning the multi inkjet head package in the inkjet recording apparatus.

According to an aspect of the invention, there is provided a multi inkjet head package including: a plurality of inkjet head assemblies each having a head plate in which an inkjet head discharging ink is housed; a rack in which the head plate is housed so as to expose the inkjet head; and a preliminary fixation portion that is installed on the rack and allows the head plate to be preliminarily fixed to the rack.

The rack may be configured to include a head plate housing portion of a height that is same as that of the head plate.

The head plate may extend to a side portion and includes a screw hole forming portion in which a screw hold is formed, and the head plate housing portion may have a screw hole formed in a position corresponding to the screw hole of the head plate on a side portion and a seat portion of the screw hole forming portion formed in a shape corresponding to the screw hole forming portion.

The screw hole forming portion and the seat portion may be configured to have rounding-processed end portions.

The preliminary fixation portion may include an elastic plate that presses a part of the head plate and a fixation pin that sets a movement range of the elastic plate.

An alignment mark may be formed in the rack, the head plate, or the rack and the head plate.

Head plates may be configured to be arranged on the rack in a single row.

The head plates may be arranged on the rack in an offset pattern.

The head plates may be consecutively tiltedly arranged on the rack.

According to another aspect of the present invention, there is provided an inkjet recording apparatus including: a multi inkjet head package that includes a preliminary fixation portion preliminarily fixing an inkjet head assembly and a rack in which an inkjet head of the inkjet head assembly is exposed; an alignment support stand that aligns the multi inkjet head package; and an alignment camera that recognizes an alignment mark formed in the multi inkjet head package.

The inkjet recording apparatus may further include a moving stage, on which a printing medium sits, allowing printing to be performed while the printing medium moves. In addition, the multi inkjet head package is fixed to the alignment support stand.

The inkjet recording apparatus may further include: a fixation stage on which the printing medium sits; and a movement support stand that allows printing to be performed while the multi inkjet head package moves on the fixation stage.

The preliminary fixation portion may be configured to include an elastic plate that presses a part of a head plate in which the inkjet head is housed and a fixation pin that sets a movement range of the elastic plate.

An alignment mark may be formed in the rack, the head plate, or the rack and the head plate.

According to another aspect of the present invention, there is provided a method of aligning a multi inkjet head. The method includes: installing a rack in an alignment support stand of an inkjet recording apparatus; disposing an inkjet head assembly in the rack and aligning the head assembly in a preliminarily fixed state by using the alignment support stand; and checking an alignment state by recognizing an alignment mark that is formed in the rack or the inkjet head assembly by using an alignment camera and fixing the inkjet head assembly to the rack.

The preliminary fixation may be configured to be performed by using an elastic plate that presses a part of a head plate that houses an inkjet head.

An alignment reference value of the inkjet head assembly may be set, and a next head assembly may be aligned by using the alignment reference value.

The method may further include aligning the rack after the installing of a rack in an alignment support stand.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view of an inkjet recording apparatus according to an embodiment of the present invention;

FIG. 2 is a schematic perspective view of a multi inkjet head package according to an embodiment of the present invention;

FIG. 3 is an exploded perspective view illustrating the appearance of installing the inkjet head assembly shown in FIG. 2 to a rack;

FIGS. 4A to 4F are schematic perspective views illustrating steps in which an inkjet head assembly is installed in a rack so as to be aligned;

FIG. 5 is a schematic diagram illustrating the appearance of aligning an inkjet head assembly through a rack;

FIGS. 6A to 6C are schematic diagrams showing the appearance of disposing inkjet head assemblies in a rack in various manners;

FIG. 7 is a flowchart showing the operations of aligning an inkjet head assembly according to an embodiment of the present invention in equipment through a rack; and

FIG. 8 is a schematic perspective view of an inkjet recording apparatus according to another embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

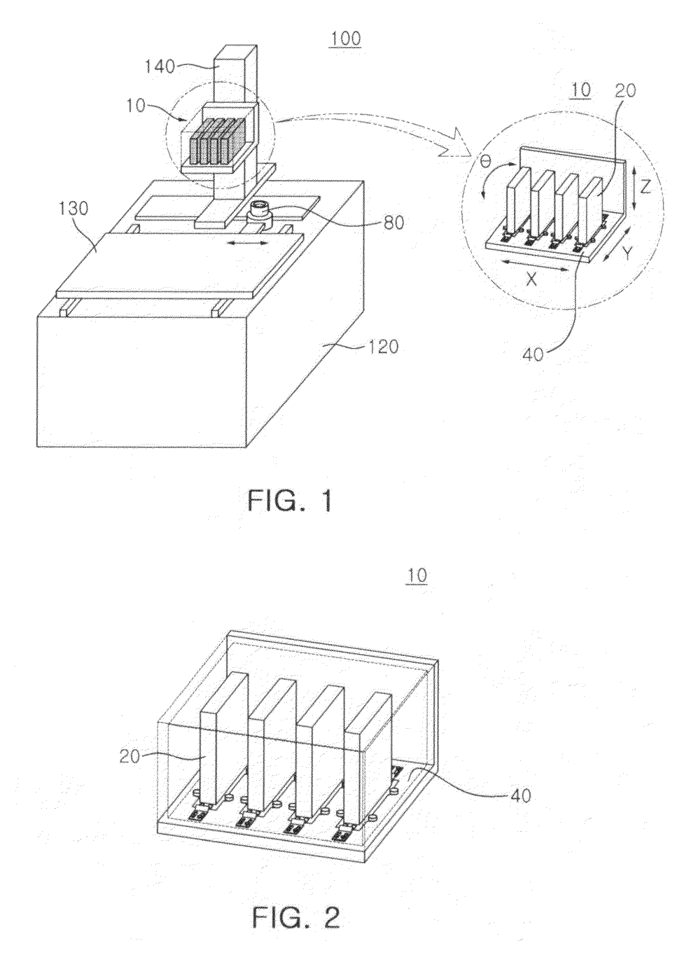

FIG. 1 is a schematic perspective view of an inkjet recording apparatus according to an embodiment of the present invention.

As shown in FIG. 1, an inkjet recording apparatus 100 according to an embodiment of the present invention may be configured to include a multi inkjet head package 10, an alignment support stand 140, and an alignment camera 80.

In the multi inkjet head package 10, inkjet heads of a plurality of inkjet head assemblies are exposed and discharge ink onto a printing medium.

The multi inkjet head package 10 may include all the technical aspects described with reference to FIGS. 2 to 6.

Here, directions for aligning an inkjet head assembly 20 in the multi inkjet head package 10 are defined as follows. Of directions X, Y, Z, and θ as shown in FIG. 1, one of directions X and Y is a main scanning direction in which a printing medium moves, and the other of directions X and Y is a sub-scanning direction that is perpendicular to the main scanning direction. In addition, direction Z is a height direction in which the inkjet head assembly 20 is installed in a rack 40, and direction θ is the direction of an angle formed by the inkjet head assembly 20 with respect to the horizontal surface of the rack 40.

Hereinafter, the directions are simply denoted by directions X, Y, Z, and θ.

The alignment support stand 140 is delicately driven in directions X, Y, Z, and θ for aligning the rack 40 in directions X, Y, Z, and θ and aligning the inkjet head assembly 20, which is disposed on the rack 40, in directions X, Y, Z, and θ of the rack 40.

In the multi inkjet head package 10, an alignment mark (a shape such as a cross, a circle, or a rectangle) is formed, and the alignment mark can be recognized by the alignment camera 80.

First, direction θ of the inkjet head assembly 20 is corrected on the horizontal plane of the rack 40 by using the alignment camera 80, such that the rack 40 and the inkjet head assembly 20 are positioned to be at a same angle. Then, the rack 40 and the inkjet head assembly 20 are corrected such that the axes in directions X and Y thereof are parallel to each other.

Before being aligned, the inkjet head assembly 20 is preliminarily fixed to the rack 40, so that a misalignment between the rack 40 and the inkjet head assembly 20 can be prevented.

In the inkjet recording apparatus 100 according to this embodiment, the multi inkjet head package 10 is provided in a state of being fixed to the alignment support stand. Here, printing is performed while a moving stage 130 on which a printing medium sits moves.

Hereinafter, the multi inkjet head package 10 will be described in detail with reference to FIGS. 2 to 6.

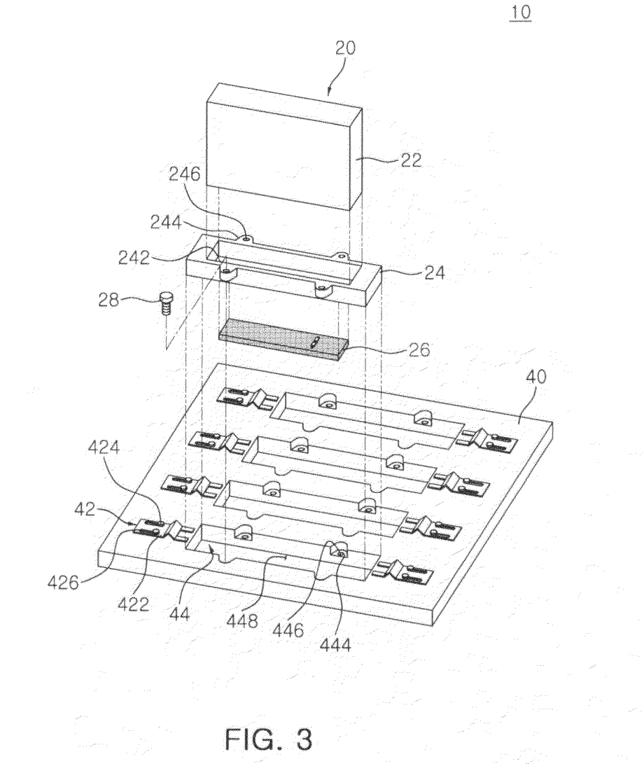

FIG. 2 is a schematic perspective view of a multi inkjet head package according to an embodiment of the present invention. FIG. 3 is an exploded perspective view illustrating the appearance of installing the inkjet head assembly shown in FIG. 2 to the rack.

As shown in FIGS. 2 and 3, the multi inkjet head package 10 according to an embodiment of the present invention may be configured to include a plurality of inkjet head assemblies 20, a rack 40, and preliminary fixation portions 42.

The inkjet head assembly 20 is configured by a cartridge 22 that is supplied with ink and stores the ink therein, an inkjet head 26 that discharges the ink supplied from the cartridge 22 in a liquid droplet form, and a head plate 24 that houses the inkjet head 26.

The head plate 24 is preliminary fixed to the rack 40 by the preliminary fixation portion 42 and then aligned. Then, the head plate 24 is fixed completely by a screw 28.

The rack 40 houses the head plate 24 so as to allow the inkjet head 26 to be exposed. The rack 40 includes a head plate housing portion 44 having the same shape as that of the head plate 24 for housing the head plate 24.

Here, the height of the head plate housing portion 44 may be configured to be equal to that of the head plate 24. The head plate housing portion 44 may be configured by a head plate housing hole 448 that allows the front face of the head plate 24 to be exposed and a seat portion 446 on which a screw hole forming portion 224 of the head plate 24 sits.

The head plate 24 extends to the side portion and includes a screw hole forming portion 244 in which a screw hole 246 is formed.

As regards the configuration of the head plate 24, the head plate housing portion 44 may have a side portion in which a screw hole 446 is formed in a position corresponding to the screw hole 246 of the head plate 24 and a seat portion 444 of the shape corresponding to the screw hole forming portion 244 is formed.

In other words, by disposing the screw hole forming portion 244 of the head plate 24 on the seat portion 444, the inkjet head 26 of the head plate 24 can be exposed externally.

Here, as the embodiment shown in the figure, the screw hole forming portion 224 and the seat portion 444 may have rounding-processed end portions.

The preliminary fixation portion 42 is a device that presses the head plate 24 so as not to move in the head plate housing portion 44 after the head plate 24 is disposed in the head plate housing portion 44 of the rack 40 as described above.

The preliminary fixation portion 42 may be configured by an elastic plate 422 that presses a part of the head plate 24 and a fixation pin 44 that sets the movement range of the elastic plate 422.

In the elastic plate 422, a movement hole 426 in which the fixation pin 44 fits is formed. The length of the movement hole 426 sets the movement length of the elastic plate 422.

In a case where the preliminary fixation is performed by the elastic plate 422, a misalignment between the rack 40 and the inkjet head assembly 20, which occurs in a case where the head plate is completely fixed by using the screw 28, can be prevented.

The above-described elastic plate 422 can be manufactured together with the rack 40. An elastic plate of a type that has sufficient rigidity to allowing separate installation and sufficient strength to withstand the rotary force of the screw is used as the elastic plate 422.

After all of the inkjet head assemblies 20 are fixed to the rack 40, an exterior cover is combined with the rack 40 so as to be manufactured in the state of a package.

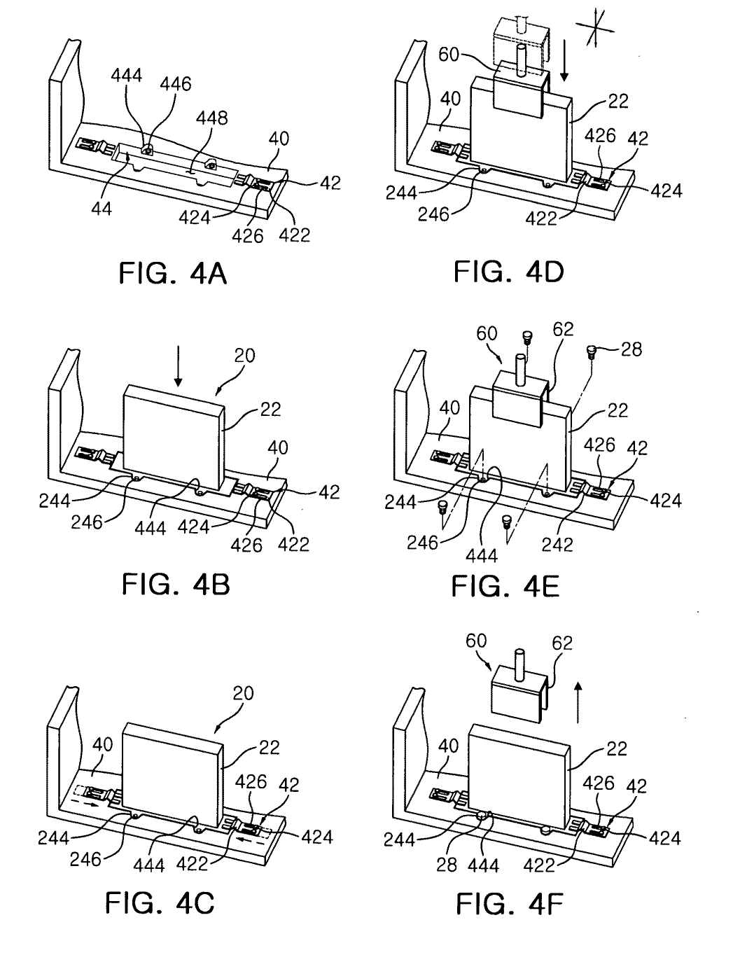

FIGS. 4A to 4F are schematic perspective views illustrating steps in which the inkjet head assembly is installed in the rack so as to be aligned.

FIGS. 4A to 4F are illustrated on a premise that the rack 40 is installed in the alignment support stand 140 of the inkjet recording apparatus 100.

FIG. 4A illustrates the rack 40 that is provided in a state of being installed to the alignment support stand 140 (see FIG. 1). The rack 40 is provided in a state in which the preliminary fixation portion 42 is open. Then, as illustrated in FIG. 4B, the inkjet head assembly 20 is housed in the rack 40, and, as illustrated in FIG. 4C, the preliminary fixation portion 42 is set so as to press a part of the head plate 24 of the inkjet head assembly 20.

Then, after being aligned in directions X, Y, Z, and θ by using a clamp 60 that is linked with the alignment support stand 140, as shown in FIG. 4D, the inkjet head assembly 20 is fixed by using the screw 28 as illustrated in FIG. 4E.

Thereafter, as illustrated in FIG. 4F, the clamp 60 is separated from the inkjet head assembly 20, and the next inkjet head assembly 20 is fixed to the rack 40. The above-described procedure is repeatedly performed.

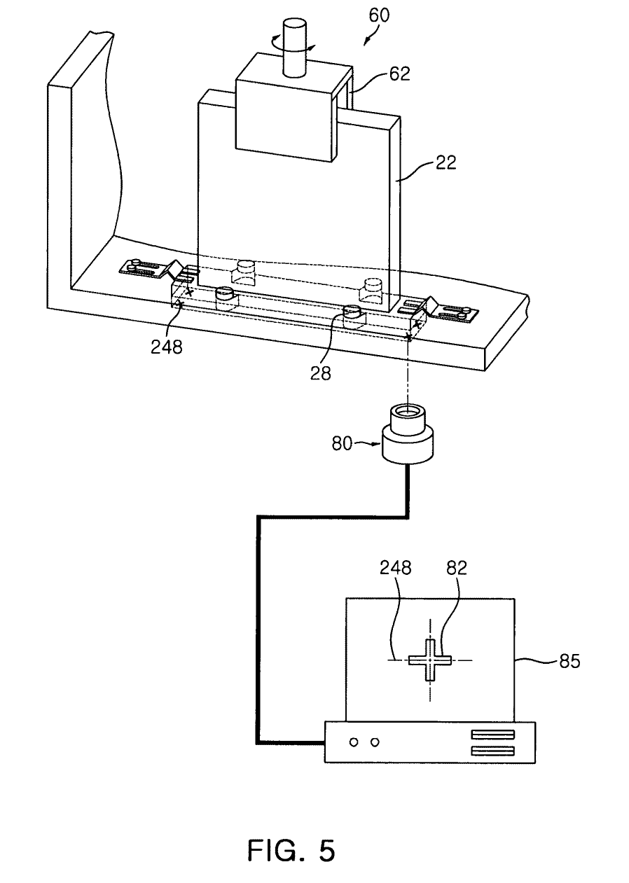

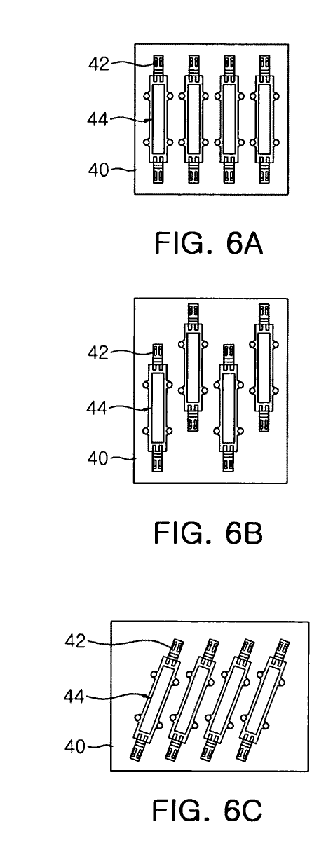

FIG. 5 is a schematic diagram illustrating the appearance of aligning the inkjet head assembly through the rack.

As illustrated in FIG. 5, a method of aligning the rack 40 as illustrated in FIG. 4D in a state in which the rack 40 is installed in the alignment support stand 140 of the inkjet recording apparatus 100 can be understood.

In addition, an alignment mark 248 can be formed in the rack 40, the head plate 24, or the rack 40 and the head plate 24.

The position of the alignment mark 248 is searched for after the alignment camera 80 is adjusted, and a deviation between an alignment reference portion 82 and the alignment mark 248 is acquired through a control unit 85. Then, alignment of the rack 40 and the inkjet head assembly 20 in the directions of X, Y, Z, and θ is performed.

FIGS. 6A to 6C are schematic diagrams showing the appearance of disposing the inkjet head assemblies in the rack in various manners.

FIG. 6A illustrates an example in which the head plates 24 are arranged on the rack 40 in a single row. FIG. 6B illustrates an example in which the head plates 24 are arranged on the rack 40 in an offset pattern. In addition, FIG. 6C illustrates an example in which the head plates 24 are consecutively tiltedly arranged on the rack 40.

The above-described modified examples are not limited to this embodiment and may be selected in various manners in accordance with the printing length.

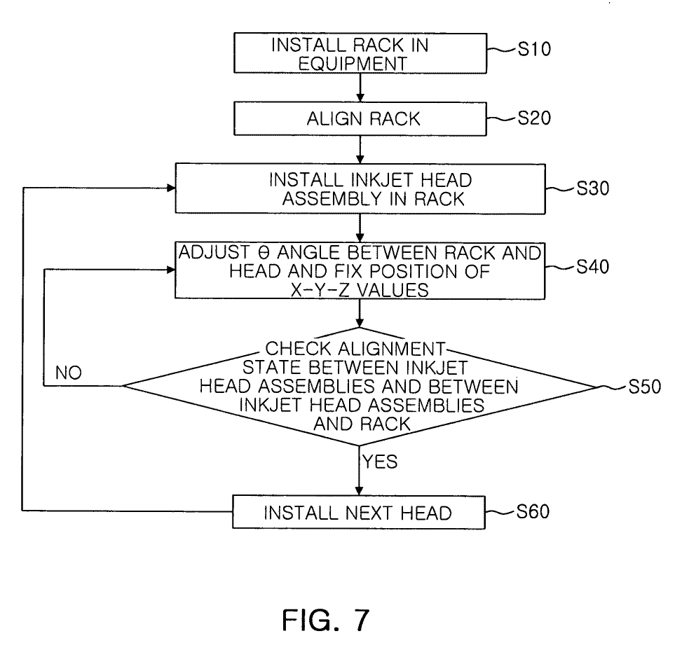

FIG. 7 is a flowchart showing the operations of aligning the inkjet head assembly according to an embodiment of the present invention in equipment through the rack.

Hereinafter, a method of aligning a multi inkjet head according to an embodiment of the present invention will be described with reference to FIG. 7. First, the rack 40 is installed in the alignment support stand 140 of the inkjet recording apparatus 100 in operation S10.

Then, the inkjet head assembly 20 is disposed in the rack 40. Then, the inkjet head assembly 20 is aligned in a preliminarily fixed state in operation S30 by the alignment support stand 140 in operation S40.

At this moment, the alignment mark 248 that is formed in the rack 40 or the inkjet head assembly 20 is recognized so as to check the alignment state in operation S50 by using the alignment camera 80, and the inkjet head assembly 20 is fixed to the rack 40 by using the screw 28.

The preliminary fixation is performed by using the preliminary fixation portion 42 of the above-described multi inkjet head package 10, and thus a detailed description thereof will be omitted.

However, the rack 40 may be aligned before the inkjet recording apparatus 10 is aligned in operation S20.

After one inkjet head assembly is aligned, an alignment reference value at that moment is set, and the next inkjet head assembly can be aligned by using the alignment reference value in operation S60.

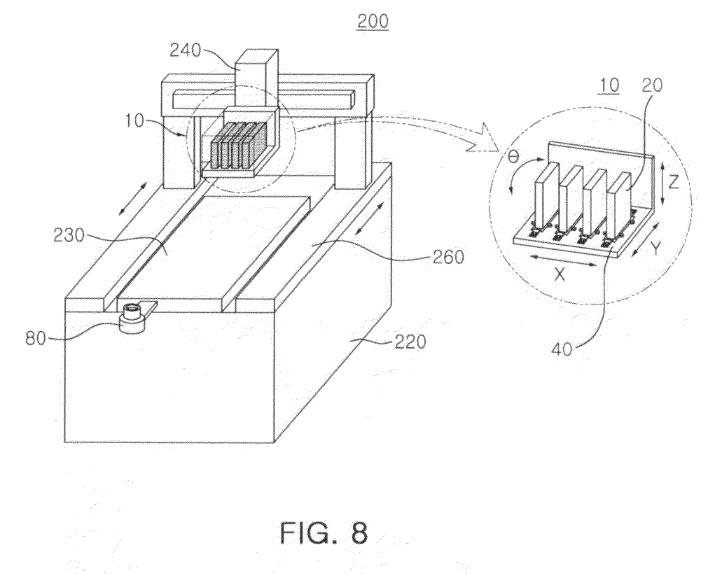

FIG. 8 is a schematic perspective view of an inkjet recording apparatus according to another embodiment of the present invention.

The inkjet recording apparatus 200 of this embodiment, similarly to the inkjet recording apparatus 100 illustrated in FIG. 1, may be configured to include a multi inkjet head package 10, an alignment support stand 140, and an alignment camera 80.

However, in this embodiment, differently from the embodiment illustrated in FIG. 1, a printing medium is maintained in a state of sitting in a fixation stage 230, and printing is performed while the multi inkjet head package 10 moves on the fixation stage 230.

At this moment, the multi inkjet head package 10 can be moved by a movement support stand 260 that is disposed on an equipment base 220.

On the other hand, all the technical aspects and the alignment methods of the multi inkjet head package 10 are also applied to the inkjet recording apparatus 200 illustrated in FIG. 8. Thus, a detailed description thereof will be omitted.

According to a multi inkjet head package, an inkjet recording apparatus using the multi inkjet head package, and a method of aligning a multi inkjet head package in the inkjet recording apparatus according to an embodiment of the present invention, an alignment process can be performed by using a single alignment support stand that controls a plurality of inkjet head assemblies in directions X, Y, Z, and θ through the rack. Therefore, the structure and the control process of the inkjet recording apparatus can be simplified.

In addition, the disposition direction of each inkjet head assembly can be changed in various manners by changing the design of the rack. Accordingly, the length of the printing head can be arbitrarily adjusted by a user.

In addition, multiple heads are manufactured as a single package by using the rack, and accordingly, the supply of the amount of flow and the pneumatic control line can be simplified.

In addition, one alignment support stand, which is expensive, controlling the inkjet head assembly in directions X, Y, Z, and θ is used. Accordingly, there are advantages in that the equipment manufacturing costs can be reduced, and embodiments of the present invention can be generally used for various equipment.

While the present invention has been shown and described in connection with the exemplary embodiments, it will be apparent to those skilled in the art that modifications and variations can be made without departing from the spirit and scope of the invention as defined by the appended claims.

What is claimed is:

1. A multi inkjet head package comprising:
a plurality of inkjet head assemblies each having a head plate in which an inkjet head discharging ink is housed;
a rack in which the head plate is housed so as to expose the inkjet head; and
a preliminary fixation portion installed on the rack and allowing the head plate to be preliminarily fixed to the rack.

2. The multi inkjet head package of claim 1, wherein the rack comprises a head plate housing portion of a height that is same as that of the head plate.

3. The multi inkjet head package of claim 2,
wherein the head plate extends to a side portion and comprises a screw hole forming portion in which a screw hold is formed, and
wherein the head plate housing portion has a screw hole formed in a position corresponding to the screw hole of the head plate on a side portion and a seat portion of the screw hole forming portion formed in a shape corresponding to the screw hole forming portion.

4. The multi inkjet head package of claim 3, wherein the screw hole forming portion and the seat portion have rounding-processed end portions.

5. The multi inkjet head package of claim 1, wherein the preliminary fixation portion comprises an elastic plate that presses a part of the head plate and a fixation pin that sets a movement range of the elastic plate.

6. The multi inkjet head package of claim 1, wherein an alignment mark is formed in the rack, the head plate, or the rack and the head plate.

7. The multi inkjet head package of claim 1, wherein head plates are arranged on the rack in a single row.

8. The multi inkjet head package of claim 1, wherein the head plates are arranged on the rack in an offset pattern.

9. The multi inkjet head package of claim 1, wherein the head plates are consecutively tiltedly arranged on the rack.

10. An inkjet recording apparatus comprising:
a multi inkjet head package comprising a preliminary fixation portion preliminarily fixing an inkjet head assembly and a rack in which an inkjet head of the inkjet head assembly is exposed;
an alignment support stand aligning the multi inkjet head package; and
an alignment camera recognizing an alignment mark formed in the multi inkjet head package.

11. The inkjet recording apparatus of claim 10, further comprising: a moving stage, on which a printing medium sits, allowing printing to be performed while the printing medium moves,
wherein the multi inkjet head package is fixed to the alignment support stand.

12. The inkjet recording apparatus of claim 10, further comprising:
a fixation stage on which the printing medium sits; and
a movement support stand allowing printing to be performed while the multi inkjet head package moves on the fixation stage.

13. The inkjet recording apparatus of claim 10, wherein the preliminary fixation portion comprises an elastic plate pressing a part of a head plate in which the inkjet head is housed and a fixation pin setting a movement range of the elastic plate.

14. The inkjet recording apparatus of claim 13, wherein an alignment mark is formed in the rack, the head plate, or the rack and the head plate.

15. A method of aligning a multi inkjet head, the method comprising:
installing a rack in an alignment support stand of an inkjet recording apparatus;
disposing an inkjet head assembly in the rack and aligning the head assembly in a preliminarily fixed state by using the alignment support stand; and
checking an alignment state by recognizing an alignment mark that is formed in the rack or the inkjet head assembly by using an alignment camera and fixing the inkjet head assembly to the rack.

16. The method of claim 15, wherein the preliminary fixation is performed by using an elastic plate that presses a part of a head plate that houses an inkjet head.

17. The method of claim 15, wherein an alignment reference value of the inkjet head assembly is set, and a next head assembly is aligned by using the alignment reference value.

18. The method of claim 15, further comprising: aligning the rack after the installing of a rack in an alignment support stand.
